(19) United States
(12) Patent Application Publication
(10) Pub. No.: US 2025/0315651 A1
(43) Pub. Date: Oct. 9, 2025

(54) POLYNOMIAL BASED TRANSFORMER

(71) Applicant: QUALCOMM Incorporated, San Diego, CA (US)

(72) Inventors: Pierre-David LETOURNEAU, Austin, TX (US); Manish Kumar SINGH, San Diego, CA (US); Hong CAI, San Diego, CA (US); Matthew Harper LANGSTON, Beacon, NY (US); Dalton James JONES, Cupertino, CA (US); Fatih Murat PORIKLI, San Diego, CA (US)

(21) Appl. No.: 18/630,233

(22) Filed: Apr. 9, 2024

(51) Int. Cl. G06N 3/045

(52) U.S. Cl. CPC G06N 3/045

(57) ABSTRACT

Certain aspects of the present disclosure provide techniques for implementing polynomial based transformer mechanisms for transforming an input tensor that includes storing the input tensor; inputting the input tensor into a transformer of a machine learning (ML) model; generating, by the transformer, one or more transformed matrices based on the input tensor; generating, by the transformer, a plurality of homogenous polynomials based on the one or more transformed matrices; generating, by the transformer, an output polynomial comprising a linear combination of the plurality of homogenous polynomials; and performing, by the ML model, one or more operations based on the output polynomial.

### INTRODUCTION

### Field of the Disclosure

Aspects of the present disclosure relate to machine learning (ML), and more particularly, to techniques for transformers for ML models.

### DESCRIPTION OF RELATED ART

Attention mechanisms, such as cross-attention and self-attention, are widely used in various applications of ML models. For example, an attention mechanism may mimic cognitive attention by calculating soft weights for inputs (e.g., embeddings, such as corresponding to words, sounds, images, etc.) in a context window. These weights can be computed in parallel, such as using a transformer, or sequentially, such as using recurrent neural networks (RNNs).

In some examples, attention mechanisms may be used in large language models (LLMs) such as to identify a highest correlation amongst inputs, such as words in a sentence. Such information may be used, for example in generative artificial intelligence (AI) mechanism, to generate images or text responsive to user prompts. Other use cases of attention mechanisms include text summarization, image captioning, machine translation, speech recognition, vision transformers for computer vision tasks (e.g., classification, detection, segmentation, depth estimation, etc.), and more.

Current attention mechanisms, however, are computationally expensive, in that they require a quadratic (O(N²)) scaling of both compute resources and memory resources with respect to input size/input sequence length of an input (e.g., input matrix or tensor, such as a vector, or N dimensional matrix or tensor) to the attention mechanism. Accordingly, certain devices, e.g., lower power devices, may not have sufficient resources to run certain ML models using certain attention mechanisms, or attention mechanism computations may have large latency.

Accordingly, techniques to transform inputs more efficiently, such as to mimic attention mechanisms, may be desired.

### SUMMARY

One aspect provides a method for transforming an input tensor. The method may include: storing the input tensor; inputting the input tensor into a transformer of a machine learning (ML) model; and generating, by the transformer, one or more transformed matrices based on the input tensor. The method may further include: generating, by the transformer, a plurality of homogenous polynomials based on the one or more transformed matrices; generating, by the transformer, an output polynomial comprising a linear combination of the plurality of homogenous polynomials; and performing, by the ML model, one or more operations based on the output polynomial.

Another aspect provides a method for transforming an input. The method may include storing the input; obtaining an indication of a number of linear transformations to perform of the input; inputting the input into a transformer of a machine learning (ML) model to perform the number of linear transformations; and performing, by the ML model, one or more operations based on the input and the number of linear transformations.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example computation flow for performing self-attention.

FIG. 2 illustrates a polynomial based transformer in accordance with at least one example of the present disclosure.

FIG. 3 depicts an example implementation of a polynomial based transformer in accordance with at least one example of the present disclosure.

FIG. 4 depicts an example implementation of a Hadamard-based attention mechanism in accordance with at least one example of the present disclosure.

FIG. 5 illustrates an example artificial intelligence (AI) architecture that maybe used for AI-enhanced wireless communications.

FIG. 6 illustrates an example AI architecture of a first wireless device that is in communication with a second wireless device.

FIG. 7 illustrates an example artificial neural network.

FIG. 8 depicts an example method for performing polynomial based attention using a transformer.

FIG. 9 depicts aspects of an example device.

### DETAILED DESCRIPTION

Aspects of the present disclosure provide apparatuses, methods, processing systems, and computer-readable mediums for polynomial based transformer mechanisms.

As discussed, current transformer mechanisms, such as attention mechanisms, pose a technical problem of being computationally expensive. For example, current transformer mechanisms may require significant resources to run certain ML models using certain attention mechanisms, or attention mechanism computations may have large latency.

Certain aspects discussed herein provide for polynomial based transformer mechanisms that provide a technical solution to such technical problem. For example, such polynomial based transformer mechanisms may only need a linear (O(N)) scaling of both compute resources and memory resources with respect to input size/input sequence length of an input (e.g., input tensor, such as a vector, or N dimensional matrix or tensor) to the transformer mechanism. Accordingly, such transformer mechanisms may provide the technical benefit of reduced compute resource and memory usage, which may improve efficiency, reduce latency of transformations, etc. For example, in certain aspects, a polynomial based transformer mechanism may utilize simple primitive operations, such as a Hadamard product, thereby improving computation efficiency, such as compared to the use of softmax or exponentials.

In certain aspects, a polynomial based transformer mechanism may be used to replace attention mechanisms (e.g., self-attention, cross-attention, etc.) in ML models with a polynomial expansion, such as a polynomial or rational function. For example, a polynomial based transformer mechanism may be used for LLMs such as to identify a highest correlation amongst inputs, such as words in a sentence. Such information may be used, for example in generative artificial intelligence (AI) mechanism, to generate images or text responsive to user prompts. Other use cases of polynomial based transformer mechanisms may include text summarization, image captioning, machine translation, speech recognition, vision transformers for computer vision tasks (e.g., classification, detection, segmentation, depth estimation, etc.), or the like.

In certain aspects, a polynomial based transformer mechanism may allow for multiple linear transformations (e.g., any number N, including four or more) of an input to be used, which allows for flexible learning in an ML model, and may be more than the number of linear transformations allowed by current attention mechanisms, providing improved performance.

In certain aspects, a polynomial based transformer mechanism may use a Hadamard product to create nonlinearity, which may not be provided by current attention mechanisms.

### Example Conventional Self-Attention Application

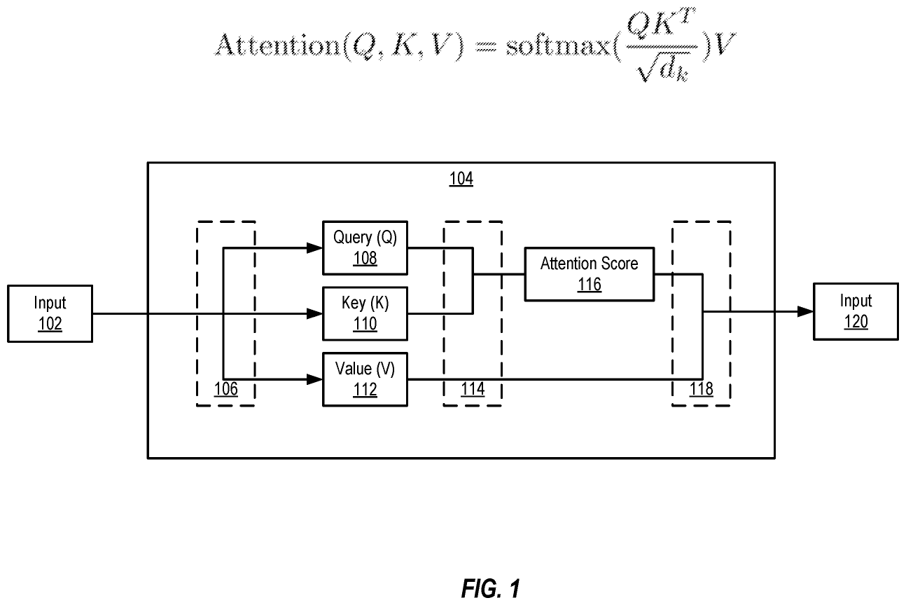

FIG. 1 depicts details of a conventional self-attention application. Self-attention is an attention mechanism commonly used in machine learning models such as transformers. In self-attention, an input is transformed into a query, key, and value. The query and key are then used to compute an attention score, representing similarities between each query and key. This attention score is applied to the value to generate the self-attention outputs. Typically, implementation of self-attention requires compute and memory resources that scale quadratically with the input sequence length. This quadratic scaling poses efficiency challenges, especially for long input sequences.

As further described with respect to FIG. 1, an input data 102 is provided to the self-attention module 104. In examples, the input data 102 may be in a matrix form (or other suitable form such as a tensor) and may comprise one or more of token embeddings such as in a natural language processing model, image features such as in a computer vision model, or speech features such as in a speech recognition model. In certain aspects, the input data 102 can have a sequence length N and embedding dimension D. The self-attention module 104 takes the input data 102 and transforms the input data 102 into separate query 108, key 110, and value 112, which may also be matrices (or other suitable data structure). In particular, the query 108, key 110, and value 112 are generated by applying learned linear transformations to the input data 102. These linear transformations are parameterized by weight matrices (or other suitable data structures) W_{q}, Wₖ, and Wᵥ respectively. By applying the weights W_{q}, Wₖ, and Wᵥ to the input data 102, the input elements can be projected into a query space (e.g., query vector space), key space (e.g., key vector space), and value space (e.g., value vector space) to derive the query 108, key 110, and value 112.

In certain aspects, a first process 106 applies the query weight W_{q} to generate the query 108 based on the input data 102. The first process 106 can also apply the key weight Wₖ to generate the key 110. The first process 106 can also apply the value weight Wᵥ to generate the value 112. The query 108 comprises queries derived from the input data 102 to be used in computing attention scores. The key 110 comprises keys that can be matched against the queries. The value 112 comprises values that are to be selectively aggregated based on generated attention scores.

In certain aspects, a second process 114 can compute an attention score 116 based on correlations, such as dot products, between the query 108 and a transpose of the key 110. For example, a matmul operation of the second process can matrix multiply the query 108 and the transpose of the key 110. In some examples, the result of the matmul operation can then be scaled by a dimension-based parameter and then a softmax operation can be applied to the scaled result. The softmax operation is a mathematical operation that turns a vector of numerical values into a vector of probabilities. In examples, a third process 118 applies the attention score 116 to the value 112 to generate the self-attention output 120, which represents the output of the self-attention computation on the input data 102.

### Example Polynomial Based Transformer

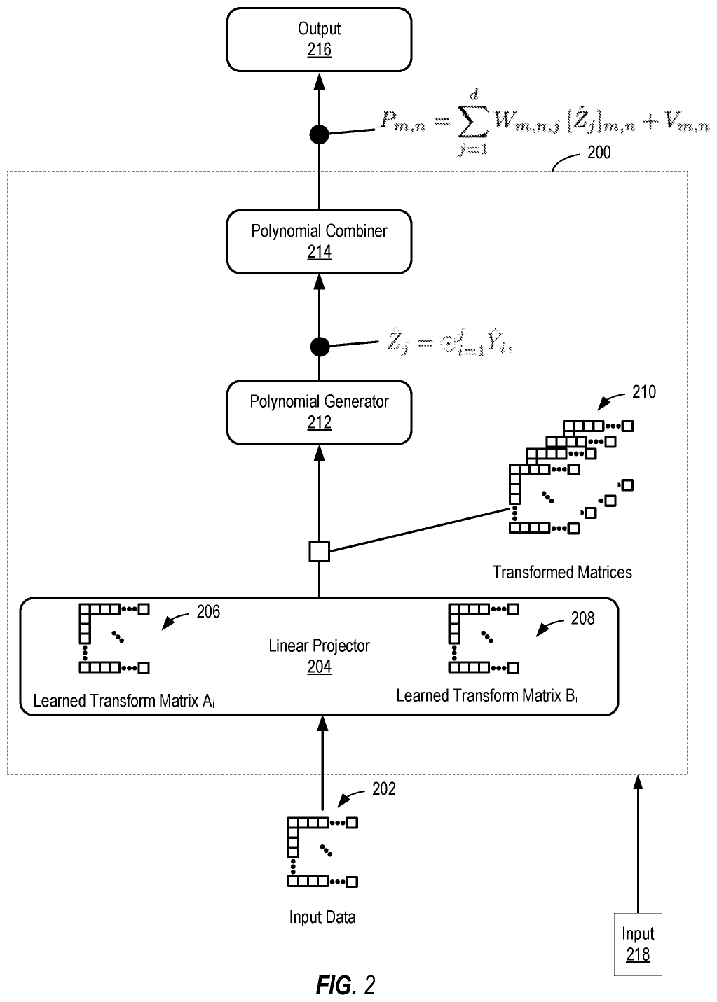

FIG. 2 illustrates an example of a polynomial based transformer 200 according to aspects of the present disclosure. In certain aspects, the polynomial based transformer 200 may be used as a drop-in replacement/substitute for an attention mechanism in a model. In certain aspects, a model may be uniquely built around the polynomial based transformer 200.

As discussed, standard attention mechanisms, such as a self-attention mechanism as illustrated in FIG. 1, may require quadratic (O(N²)) scaling of computational and memory resources based on a sequence length N of the input data to the attention mechanism. In contrast, the polynomial based transformer 200 can provide computational and memory efficiencies over standard attention mechanisms through the use of polynomial expansion, such as through use of a polynomial/rational function. Such a polynomial based transformer 200 may only need a linear (O(N)) scaling of both compute resources and memory resources with respect to input size/input sequence length of an input (e.g., input tensor, such as a vector, or N dimensional matrix or tensor) to the polynomial based transformer 200.

As shown in FIG. 2, the input data 202 may be input into the polynomial based transformer 200, where the input data 202 may refer to the same input data 102 of FIG. 1. The input data 202 and various other data structures used by polynomial based transformer 200 are described as matrices, as an example. However, it should be noted that other suitable types of data structures may be used. For example, the input data 202 may comprise a sequence of token embeddings, image features, or speech features for processing, such as through an attention mechanism.

In certain aspects, the input data 202 is input into a linear projector 204, of polynomial based transformer 200, that is configured to generate one or more transformed matrices 210 corresponding to one or more transformations of input data 202. In certain aspects, the number of one or more transformed matrices 210 generated may be selectable, such as based on an input 218 (e.g., user input) indicating a number of transformed matrices to be generated. In certain aspects, the one or more transformed matrices 210 correspond to linear projections (e.g., linear transformations) of input data 202. In certain aspects, the number of one or more transformed matrices 210 is at least four, which may allow for more flexible learning and improved performance over standard attention mechanisms capable of only utilizing a fixed (i.e., non-selectable) three transformed matrices (e.g., key, value, and query). In certain aspects, the number of one or more transformed matrices 210 is less than four.

In certain aspects, to generate a given transformed matrix Yᵢ, linear projector 204 applies (e.g., through matrix multiplication) a transform matrix Aᵢ 206 to the left of the input data 202 and a transform matrix Bᵢ 208 to the right of the input data 202. In certain aspects, applying matrix multiplication to both the left and right of input data 202 may provide more expressive power versus just applying matrix multiplication on one side of input data 202, such as in standard attention mechanisms. The resulting matrix is the transformed matrix Yᵢ. Each of one or more transformed matrices 210, therefore, may be generated using a different corresponding pair of transform matrices A and B. For example, each of the transformed matrices 210 may be generated using the following equation:

$${Y}_{i} = {A}_{i} \times {B}_{i}$$

In certain aspects, each transform matrix Aᵢ 206 and each transform matrix Bᵢ 208 may be learned (e.g., using backpropagation techniques) during a machine-learning model training of a machine-learning model including polynomial based transformer 200. In certain aspects, each transform matrix Aᵢ 206 and each transform matrix Bᵢ 208 may be of low-rank and/or sparse, meaning the computations may be performed efficiently for calculation of transformed matrices 210.

The one or more transformed matrices 210 may be used as input into a polynomial generator 212, of polynomial based transformer 200, configured to generate a plurality of polynomials (e.g., homogenous polynomials) based on the one or more transformed matrices 210. In certain aspects, the plurality of polynomials may correspond to monomials of the one or more transformed matrices 210. In certain aspects, the one or more transformed matrices 210 may be normalized, prior to being input into polynomial generator 212, or be normalized by polynomial generator 212, prior to being used to generate the plurality of polynomials.

In certain aspects, the polynomial generator 212 can generate homogenous polynomials using element-wise multiplication operations, sometimes referred to as Hadamard products. For example, the polynomial generator 212 can generate homogenous polynomials Zⱼ (e.g., normalized homogenous polynomials \hat{Z}ⱼ) according to the following equation:

$${\hat{Z}}_{j} = {⊙}_{i = 1}^{j} {\hat{Y}}_{i} ,$$

where, Ŷᵢ may be a normalized computation of each transformed matrix 210 Yᵢ. In some examples, Ŷᵢ may be obtained via a sum of squares computing of Yᵢ. In some aspects, \hat{Z}ⱼ may be replaced by Zⱼ and Ŷᵢ may be replaced by Y in the equation. In certain aspects, use of a Hadamard product between normalized versions of transformed matrices 210 may create nonlinearity with any polynomial degree greater than or equal to 2.

In certain aspects, the plurality of homogenous polynomials Zⱼ (e.g., normalized homogenous polynomials \hat{Z}ⱼ are input into polynomial combiner 214, of polynomial based transformer 200, configured to generate an output polynomial comprising a linear combination of the plurality of homogenous polynomials Zⱼ.

For example, at the polynomial combiner 214, the output polynomial P_{m,n} may be constructed in accordance with the following equation:

$${P}_{m , n} = {\sum }_{j = 1}^{d} {{W}_{m , n , j} [ {\hat{Z}}_{j} ]}_{m , n} + {V}_{m , n}$$

where W_{m,n,j} and V_{m,n}, may be parameters learned (e.g., using backpropagation techniques) during a machine-learning model training of a machine-learning model including polynomial based transformer 200. For example, W may represent a learned linear transformation, such as a weighted matrix, that is applied to the intermediate polynomials Z, and V may represent a learned bias vector.

In certain aspects, the output 216 may be the output polynomial. In certain aspects, the output 216 may be obtained by adjusting the size of the output polynomial, such that it matches the size of the input data 202, such as through linear projection of the output polynomial. For example, through matrix multiplication, a transform matrix U may be applied to the left of the output polynomial and a transform matrix Y may be applied to the right of the output polynomial to generate output 216.

In certain aspects, output 216 may be used to perform one or more operations for an ML model, such as for any of the use cases discussed herein.

For example, in certain aspects, the parameters of the transform matrices 206 and 208 are learned in order to approximate standard self-attention computations. In some aspects, backpropagation may be used to learn such parameters together with the parameters W and V. During training, a loss function comparing the outputs of the polynomial based transformer to true self-attention outputs could be calculated. Thus, loss gradients with respect to the matrix parameters of transform matrices 206 and 208 and W and V would then be propagated backwards through the computations. Gradient descent style parameter updates could adapt the values of the transform matrices 206 and 208, and W and V, to minimize the loss function over training iterations.

### Example Polynomial Attention Module

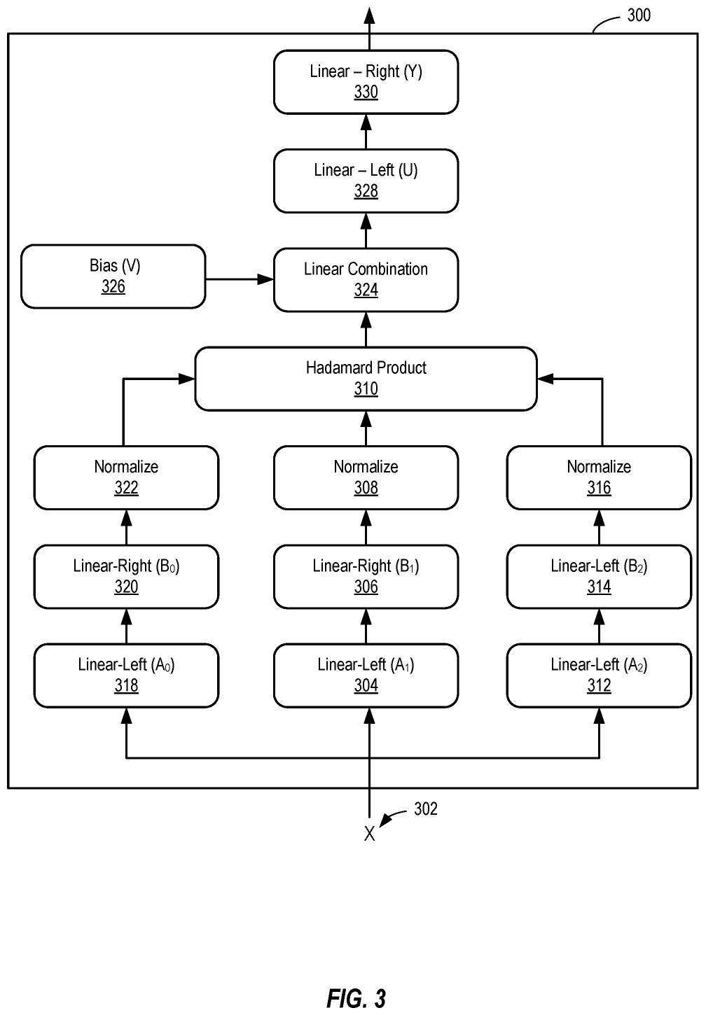

FIG. 3 depicts an implementation of the polynomial based transformer 200 as a polynomial attention module 300 according to aspects of the current disclosure. In certain aspects, multiple successive stages of linear transformations, and normalized element-wise multiplication, build a polynomial approximation that replicates self-attention. In certain aspects, input data 302 is provided to the polynomial attention module 300. In certain aspects, input data 302 may comprise embeddings, such as token, image, or speech embeddings to be processed by a machine-learning model.

At a first stage, linear transforms 304 and 306 are applied to the input data 302 on the left and right respectively. The linear transforms 304 and 306 represent learned projection of the input data 302 into an approximation space, which can be parameterized as matrices A₁ and B₁. As previously described, the projection of the input data 302 may correspond to a transformed matrix. In some examples, a normalization operation 308 may be applied to the transformed matrix.

Further, in this example, in the first stage, linear transforms 318 and 320 are similarly applied to input data 302, to generate another transformed matrix. In some examples, a normalization operation 322 may be applied to the transformed matrix.

Further, in this example, in the first stage, linear transforms 312 and 314 are similarly applied to input data 302, to generate another transformed matrix. In some examples, a normalization operation 316 may be applied to the transformed matrix.

Continuing, a Hadamard product 310 (element-wise multiplication) is applied to the transformed matrices (e.g., the three normalized transformed matrices) to generate a plurality of homogeneous polynomials.

In some aspects, the linear combination block 324, such as using a bias 326, combines the plurality of homogeneous polynomials to generate an output polynomial. For example, linear combination block 324 could take linear combinations like sums or weighted mixes of the plurality of homogeneous polynomials to provide different polynomial orders and to better reflect attention.

The linear transform blocks 328 and 330 provide additional projection to transform the output polynomial from linear combination block 324. In some aspects, a linear-left block 328 may apply a matrix to the left of the output polynomial and a linear-right block 330 may apply a matrix to the right of the output polynomial to project the output polynomial to an approximation space, such as to an output space matching expected attention output dimensions. These final transform blocks 328 and 330 can allow the reshaping of outputs to match a desired size, such as the size of the input data 302.

### Example Hadamard-Based Attention Mechanism

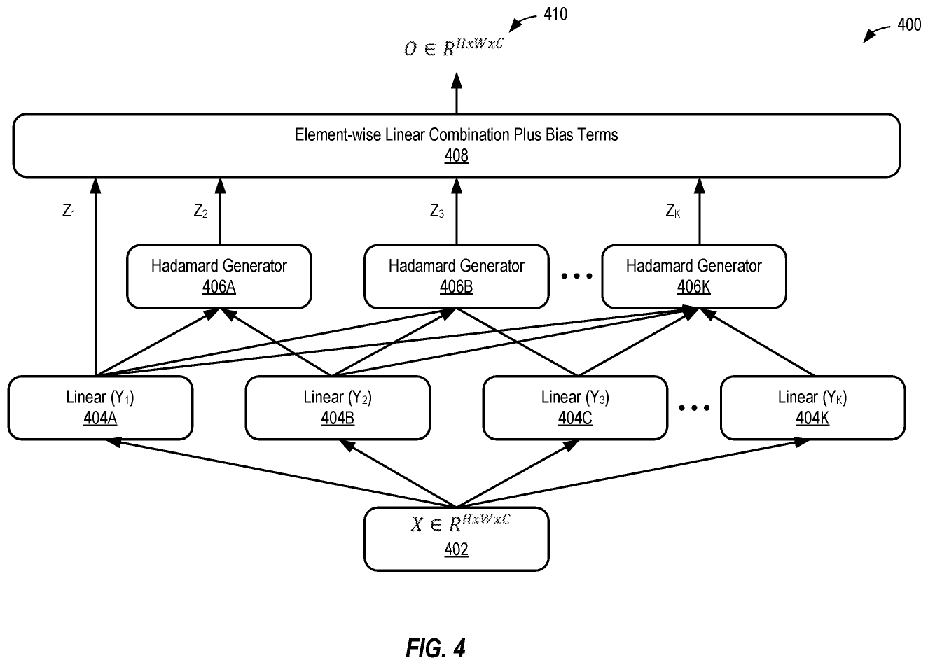

FIG. 4 depicts an implementation of a Hadamard-based attention mechanism according to aspects of the current disclosure. The Hadamard-based attention mechanism relies on Hadamard products and transformations to provide hardware efficient non-linear transformations. In some aspects, the input data 402 enters the Hadamard attention block. The input data 402 may comprise image features, token embeddings, or other representations to be processed by the system using attention-based operations.

In certain aspects, the input data 402 may be processed through multiple parallel paths comprising linear transformations to project representations into an attention approximation space. For example, the input data 402 may be linearly transformed at one or more of 404A to 404K. In some aspects, the linearly transformed input data from blocks 404A to 404K may be provided to Hadamard generators blocks 406A to 406K. For example, the Hadamard generator blocks 406A to 406K may accumulate element-wise multiplications between the transformed representations to provide high-order non-linear relationships that can better model convention standard attention. In certain aspects, the outputs from the Hadamard generator blocks 406A to 406K are combined using element-wise linear operations at 408 together with one or more bias terms to generate output 410.

### Example Artificial Intelligence System for Polynomial Based Transformer Mechanisms

Certain aspects described herein may be implemented, at least in part, using some form of artificial intelligence (AI), e.g., the process of using a machine learning (ML) model to infer or predict output data based on input data. An example ML model may include a mathematical representation of one or more relationships among various objects to provide an output representing one or more predictions or inferences. Once an ML model has been trained, the ML model may be deployed to process data that may be similar to, or associated with, all or part of the training data and provide an output representing one or more predictions or inferences based on the input data.

ML is often characterized in terms of types of learning that generate specific types of learned models that perform specific types of tasks. For example, different types of machine learning include supervised learning, unsupervised learning, semi-supervised learning, and reinforcement learning.

Supervised learning algorithms generally model relationships and dependencies between input features (e.g., a feature vector) and one or more target outputs. Supervised learning uses labeled training data, which are data including one or more inputs and a desired output. Supervised learning may be used to train models to perform tasks like classification, where the goal is to predict discrete values, or regression, where the goal is to predict continuous values. Some example supervised learning algorithms include nearest neighbor, naive Bayes, decision trees, linear regression, support vector machines (SVMs), and artificial neural networks (ANNs).

Unsupervised learning algorithms work on unlabeled input data and train models that take an input and transform it into an output to solve a practical problem. Examples of unsupervised learning tasks are clustering, where the output of the model may be a cluster identification, dimensionality reduction, where the output of the model is an output feature vector that has fewer features than the input feature vector, and outlier detection, where the output of the model is a value indicating how the input is different from a typical example in the dataset. An example unsupervised learning algorithm is k-Means.

Semi-supervised learning algorithms work on datasets containing both labeled and unlabeled examples, where often the quantity of unlabeled examples is much higher than the number of labeled examples. However, the goal of a semi-supervised learning is that of supervised learning. Often, a semi-supervised model includes a model trained to produce pseudo-labels for unlabeled data that is then combined with the labeled data to train a second classifier that leverages the higher quantity of overall training data to improve task performance.

Reinforcement Learning algorithms use observations gathered by an agent from an interaction with an environment to take actions that may maximize a reward or minimize a risk. Reinforcement learning is a continuous and iterative process in which the agent learns from its experiences with the environment until it explores, for example, a full range of possible states. An example type of reinforcement learning algorithm is an adversarial network. Reinforcement learning may be particularly beneficial when used to improve or attempt to optimize a behavior of a model deployed in a dynamically changing environment, such as a wireless communication network.

ML models may be deployed in one or more devices (e.g., network entities such as base station(s) and/or user equipment(s)) to support various wired and/or wireless communication aspects of a communication system. For example, an ML model may be trained to identify patterns and relationships in data corresponding to a network, a device, an air interface, or the like. An ML model may improve operations relating to one or more aspects, such as transceiver circuitry controls, frequency synchronization, timing synchronization, channel state estimation, channel equalization, channel state feedback, modulation, demodulation, device positioning, transceiver tuning, beamforming, signal coding/decoding, network routing, load balancing, and energy conservation (to name just a few) associated with communications devices, services, and/or networks. AI-enhanced transceiver circuitry controls may include, for example, filter tuning, transmit power controls, gain controls (including automatic gain controls), phase controls, power management, and the like.

Aspects described herein may describe the performance of certain tasks and the technical solution of various technical problems by application of a specific type of ML model, such as an ANN. It should be understood, however, that other type(s) of AI models may be used in addition to or instead of an ANN. An ML model may be an example of an AI model, and any suitable AI model may be used in addition to or instead of any of the ML models described herein. Hence, unless expressly recited, subject matter regarding an ML model is not necessarily intended to be limited to just an ANN solution or machine learning. Further, it should be understood that, unless otherwise specifically stated, terms such “AI model,” “ML model,” “AI/ML model,” “trained ML model,” and the like are intended to be interchangeable.

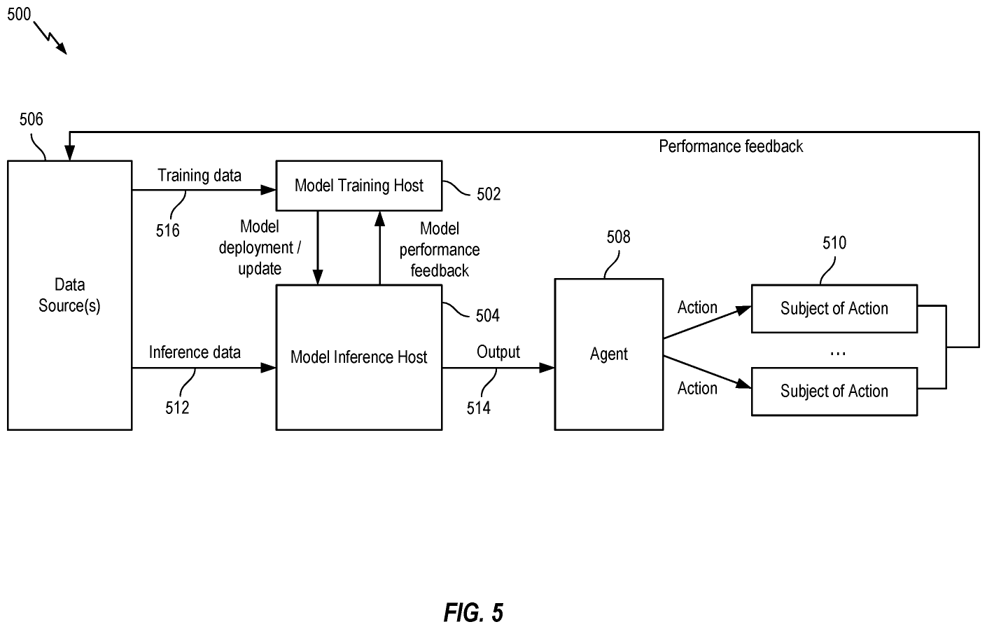

FIG. 5 is a diagram illustrating an example AI architecture 500 that may be used for performing polynomial-based attention using a transformer as described above with respect to FIGS. 1-4. As illustrated in FIG. 5, the architecture 500 includes multiple logical entities, such as a model training host 502, a model inference host 504, data source(s) 506, and an agent 508. The AI architecture may be used in any of various use cases for wireless communications, such as those listed above.

The model inference host 504, in the architecture 500, is configured to run an ML model based on inference data 512 provided by data source(s) 506. The model inference host 504 may produce an output 514 (e.g., a prediction or inference, such as a discrete or continuous value) based on the inference data 512, that is then provided as input to the agent 508.

The agent 508 may be an element or an entity of a wireless communication system including, for example, a radio access network (RAN), a wireless local area network, a device-to-device (D2D) communications system, etc. As an example, the agent 508 may be a user equipment (UE), a base station or any disaggregated network entity thereof including a centralized unit (CU), a distributed unit (DU), and/or a radio unit (RU)), an access point, a wireless station, a RAN intelligent controller (RIC) in a cloud-based RAN, among some examples. Additionally, the type of agent 508 may also depend on the type of tasks performed by the model inference host 504, the type of inference data 512 provided to model inference host 504, and/or the type of output 514 produced by model inference host 504.

For example, if output 514 from the model inference host 504 is associated with a polynomial based transformer mechanisms, the agent 508 may be user equipment that includes a gaming console GPU or a specialized graphics card. As another example, if output 514 from model inference host 504 is associated with a polynomial based transformer mechanisms, the agent 508 may be an ML engine.

After the agent 508 receives output 514 from the model inference host 504, agent 508 may determine whether to act based on the output. For example, if agent 508 is a chatbot agent and the output 514 from model inference host 504 suggests that a factual query may be warranted, the agent 508 may determine to obtain conversational responses or defer to human operators if a confidence in an output is low. Alternatively, the agent 508 may directly formulate natural language responses based on decoded embeddings.

The data sources 506 may be configured for collecting data that is used as training data 516 for training an ML model, or as inference data 512 for feeding an ML model inference operation. In particular, the data sources 506 may collect data from any of various entities (e.g., application logs, human transcripts, user feedback, etc.), which may include the subject of action 510, and provide the collected data to a model training host 502 for ML model training. For example, after a subject of action 510 (e.g., performing polynomial based transformer mechanism related operation) receives a reconstructed image from an agent 508, the subject of action 510 may provide performance feedback associated with the reconstructed image to the data sources 506, where the performance feedback may be used by the model training host 502 for monitoring and/or evaluating the ML model performance, such as whether the output 514, provided to agent 508, is accurate. In some examples, if the output 514 provided to agent 508 is inaccurate (or the accuracy is below an accuracy threshold), the model training host 502 may determine to modify or retrain the ML model used by model inference host 504, such as via an ML model deployment/update.

For example, in some aspects, initially replacing self-attention blocks with polynomial based transformer mechanisms may lead to slightly degraded performance. As evaluated by human judges or semi-automated metrics, excessive off-base responses could prompt additional training focused on the polynomial based transformer mechanisms responsible for the off-based responses. For example, when considering chat bot integrations, the system continues updating and reverting changes until a chat bot performance qualitatively matches baseline standards. In some examples, if the output of the polynomial based transformer mechanisms is inaccurate compared to the conventional or ground truth data (e.g., self-attention data), the model training host 502 may determine to fine-tune the model parameters or switch to an enhanced architecture via model update. In certain aspects, the model training host 502 may be deployed at or with the same or a different entity than that in which the model inference host 504 is deployed. For example, in order to offload model training processing, which can impact the performance of the model inference host 504, the model training host 502 may be deployed at a model server as further described herein. Further, in some cases, training and/or inference may be distributed amongst devices in a decentralized or federated fashion.

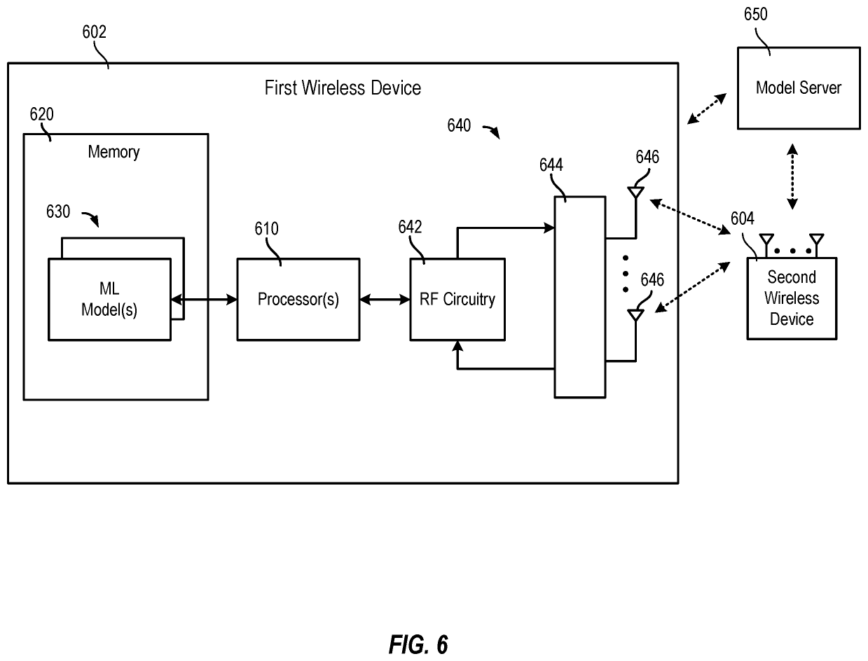

FIG. 6 illustrates an example AI architecture of a first wireless device 602 that is in communication with a second wireless device 604. The first wireless device 602 may be for performing polynomial based transformer mechanisms as described herein with respect to FIGS. 1-5. Similarly, the second wireless device 604 may be for performing polynomial based transformer mechanisms as described herein with respect to FIGS. 1-5. Note that the AI architecture of the first wireless device 602 may be applied to the second wireless device 604.

The first wireless device 602 may be, or may include, a chip, system on chip (SoC), a system in package (SiP), chipset, package or device that includes one or more processors, processing blocks or processing elements (collectively “the processor 610”) and one or more memory blocks or elements (collectively “the memory 620”).

As an example, in a transmit mode, the processor 610 may transform information (e.g., packets or data blocks) into modulated symbols. As digital baseband signals (e.g., digital in-phase (I) and/or quadrature (Q) baseband signals representative of the respective symbols), the processor 610 may output the modulated symbols to a transceiver 640. The processor 610 may be coupled to the transceiver 640 for transmitting and/or receiving signals via one or more antennas 646. In this example, the transceiver 640 includes radio frequency (RF) circuitry 642, which may be coupled to the antennas 646 via an interface 644. As an example, the interface 644 may include a switch, a duplexer, a diplexer, a multiplexer, and/or the like. The RF circuitry 642 may convert the digital signals to analog baseband signals, for example, using a digital-to-analog converter. The RF circuitry 642 may include any of various circuitry, including, for example, baseband filter(s), mixer(s), frequency synthesizer(s), power amplifier(s), and/or low noise amplifier(s). In some cases, the RF circuitry 642 may upconvert the baseband signals to one or more carrier frequencies for transmission. The antennas 646 may emit RF signals, which may be received at the second wireless device 604.

In receive mode, RF signals received via the antenna 646 (e.g., from the second wireless device 604) may be amplified and converted to a baseband frequency (e.g., downconverted). The received baseband signals may be filtered and converted to digital I or Q signals for digital signal processing. The processor 610 may receive the digital I or Q signals and further process the digital signals, for example, demodulating the digital signals.

One or more ML models 630 may be stored in the memory 620 and accessible to the processor(s) 610. In certain cases, different ML models 630 with different characteristics may be stored in the memory 620, and a particular ML model 630 may be selected based on its characteristics and/or application as well as characteristics and/or conditions of first wireless device 602 (e.g., a power state, a mobility state, a battery reserve, a temperature, etc.). For example, the ML models 630 may have different inference data and output pairings (e.g., different types of inference data produce different types of output), different levels of accuracies (e.g., 80%, 90%, or 95% accurate) associated with the predictions (e.g., the output 514 of FIG. 5), different latencies (e.g., processing times of less than 10 ms, 100 ms, or 1 second) associated with producing the predictions, different ML model sizes (e.g., file sizes), different coefficients or weights, etc.

The processor 610 may use the ML model 630 to produce output data (e.g., the output 514 of FIG. 5) based on input data (e.g., the inference data 512 of FIG. 5), for example, as described herein with respect to the inference host 504 of FIG. 5. The ML model 630 may be used to perform any of various AI-enhanced tasks, such as those listed above.

As an example, the ML model 630 may generate image-based information, textual based information, and/or other information having undergone a transformer-based attention application. The input data may include, for example, an image, conventional self-attention parameters, text information, etc. The output data may include, for example, a reconstructed image, trained parameters, or created text information as previously described. Note that other input data and/or output data may be used in addition to or instead of the examples described herein. Note that other input data and/or output data may be used in addition to or instead of the examples described herein.

In certain aspects, a model server 650 may perform any of various ML model lifecycle management (LCM) tasks for the first wireless device 602 and/or the second wireless device 604. The model server 650 may operate as the model training host 502 of FIG. 5 and update the ML model 630 using training data. In some cases, the model server 650 may operate as the data source 506 of FIG. 5 to collect and host training data, inference data, and/or performance feedback associated with an ML model 630. In certain aspects, the model server 650 may host various types and/or versions of the ML models 630 for the first wireless device 602 and/or the second wireless device 604 to download.

In some cases, the model server 650 may monitor and evaluate the performance of the ML model 630 to trigger one or more LCM tasks. For example, the model server 650 may determine whether to activate or deactivate the use of a particular ML model at the first wireless device 602 and/or the second wireless device 604, and the model server 650 may provide such an instruction to the respective first wireless device 602 and/or the second wireless device 604. In some cases, the model server 650 may determine whether to switch to a different ML model 630 being used at the first wireless device 602 and/or the second wireless device 604, and the model server 650 may provide such an instruction to the respective first wireless device 602 and/or the second wireless device 604. In yet further examples, the model server 650 may also act as a central server for decentralized machine learning tasks, such as federated learning.

### Example Artificial Intelligence Model

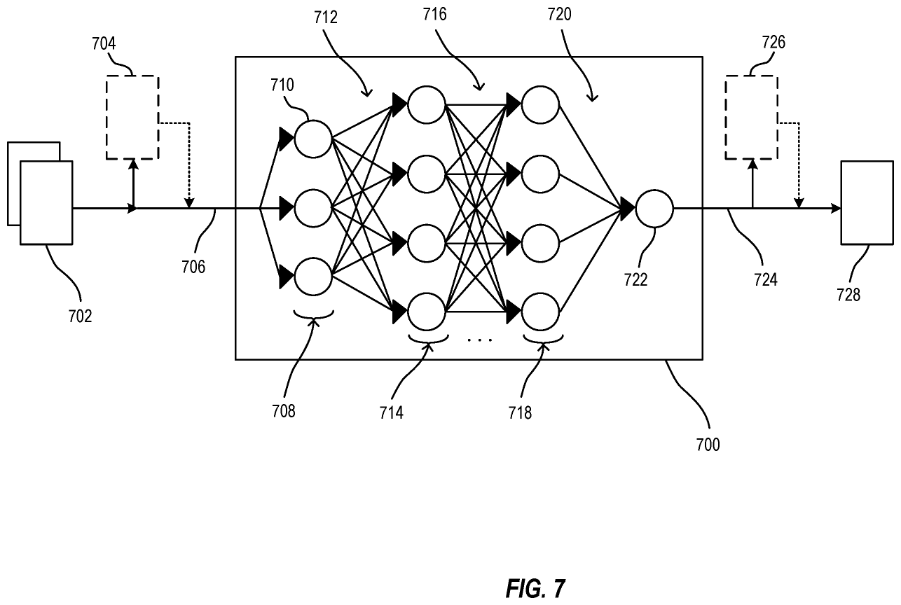

FIG. 7 is an illustrative block diagram of an example artificial neural network (ANN) 700.

ANN 700 may receive input data 706 which may include one or more bits of data 702, pre-processed data output from pre-processor 704 (optional), or some combination thereof. Here, data 702 may include training data, verification data, application-related data, or the like, e.g., depending on the stage of development and/or deployment of ANN 700. Pre-processor 704 may be included within ANN 700 in some other implementations. Pre-processor 704 may, for example, process all or a portion of data 702 which may result in some of data 702 being changed, replaced, deleted, etc. In some implementations, pre-processor 704 may add additional data to data 702.

ANN 700 includes at least one first layer 708 of artificial neurons 710 (e.g., perceptrons) to process input data 706 and provide resulting first layer output data via edges 712 to at least a portion of at least one second layer 714. Second layer 714 processes data received via edges 712 and provides second layer output data via edges 716 to at least a portion of at least one third layer 718. Third layer 718 processes data received via edges 716 and provides third layer output data via edges 720 to at least a portion of a final layer 722 including one or more neurons to provide output data 724. All or part of output data 724 may be further processed in some manner by (optional) post-processor 726. Thus, in certain examples, ANN 700 may provide output data 728 that is based on output data 724, post-processed data output from post-processor 726, or some combination thereof. Post-processor 726 may be included within ANN 700 in some other implementations. Post-processor 726 may, for example, process all or a portion of output data 724 which may result in output data 728 being different, at least in part, to output data 724, e.g., as result of data being changed, replaced, deleted, etc. In some implementations, post-processor 726 may be configured to add additional data to output data 724. In this example, second layer 714 and third layer 718 represent intermediate or hidden layers that may be arranged in a hierarchical or other like structure. Although not explicitly shown, there may be one or more further intermediate layers between the second layer 714 and the third layer 718.

The structure and training of artificial neurons 710 in the various layers may be tailored to specific requirements of an application. Within a given layer of an ANN, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer. Artificial neurons in such a layer may be activated by or be responsive to weights and biases that may be adjusted during a training process. Weights of the various artificial neurons may act as parameters to control a strength of connections between layers or artificial neurons, while biases may act as parameters to control a direction of connections between the layers or artificial neurons. An activation function may select or determine whether an artificial neuron transmits its output to the next layer or not in response to its received data. Different activation functions may be used to model different types of non-linear relationships. By introducing non-linearity into an ML model, an activation function allows the ML model to “learn” complex patterns and relationships in the input data (e.g., 506 in FIG. 5). Some non-exhaustive example activation functions include a linear function, binary step function, sigmoid, hyperbolic tangent (tanh), a rectified linear unit (ReLU) and variants, exponential linear unit (ELU), Swish, Softmax, and others.

Design tools (such as computer applications, programs, etc.) may be used to select appropriate structures for ANN 700 and a number of layers and a number of artificial neurons in each layer, as well as selecting activation functions, a loss function, training processes, etc. Once an initial model has been designed, training of the model may be conducted using training data. Training data may include one or more datasets within which ANN 700 may detect, determine, identify or ascertain patterns. Training data may represent various types of information, including written, visual, audio, environmental context, operational properties, etc. During training, parameters of artificial neurons 710 may be changed, such as to minimize or otherwise reduce a loss function or a cost function. A training process may be repeated multiple times to fine-tune ANN 700 with each iteration.

Various ANN model structures are available for consideration. For example, in a feedforward ANN structure each artificial neuron 710 in a layer receives information from the previous layer and likewise produces information for the next layer. In a convolutional ANN structure, some layers may be organized into filters that extract features from data (e.g., training data and/or input data). In a recurrent ANN structure, some layers may have connections that allow for processing of data across time, such as for processing information having a temporal structure, such as time series data forecasting.

In an autoencoder ANN structure, compact representations of data may be processed and the model trained to predict or potentially reconstruct original data from a reduced set of features. An autoencoder ANN structure may be useful for tasks related to dimensionality reduction and data compression.

A generative adversarial ANN structure may include a generator ANN and a discriminator ANN that are trained to compete with each other. Generative-adversarial networks (GANs) are ANN structures that may be useful for tasks relating to generating synthetic data or improving the performance of other models.

A transformer ANN structure makes use of attention mechanisms that may enable the model to process input sequences in a parallel and efficient manner. An attention mechanism allows the model to focus on different parts of the input sequence at different times. Attention mechanisms may be implemented using a series of layers known as attention layers to compute, calculate, determine or select weighted sums of input features based on a similarity between different elements of the input sequence. A transformer ANN structure may include a series of feedforward ANN layers that may learn non-linear relationships between the input and output sequences. The output of a transformer ANN structure may be obtained by applying a linear transformation to the output of a final attention layer. A transformer ANN structure may be of particular use for tasks that involve sequence modeling, or other like processing.

Another example type of ANN structure, is a model with one or more invertible layers. Models of this type may be inverted or “unwrapped” to reveal the input data that was used to generate the output of a layer.

Other example types of ANN model structures include fully connected neural networks (FCNNs) and long short-term memory (LSTM) networks.

ANN 700 or other ML models may be implemented in various types of processing circuits along with memory and applicable instructions therein, for example, as described herein with respect to FIGS. 6 and 7. For example, general-purpose hardware circuits, such as, such as one or more central processing units (CPUs) and one or more graphics processing units (GPUs) may be employed to implement a model. One or more ML accelerators, such as tensor processing units (TPUs), embedded neural processing units (eNPUs), or other special-purpose processors, and/or field-programmable gate arrays (FPGAs), application-specific integrated circuits (ASICs), or the like also may be employed. Various programming tools are available for developing ANN models.

### Aspects of Artificial Intelligence Model Training

There are a variety of model training techniques and processes that may be used prior to, or at some point following, deployment of an ML model, such as ANN 700 of FIG. 7.

As part of a model development process, information in the form of applicable training data may be gathered or otherwise created for use in training an ML model accordingly. For example, training data may be gathered or otherwise created regarding information associated with received/transmitted signal strengths, interference, and resource usage data, as well as any other relevant data that might be useful for training a model to address one or more problems or issues in a communication system. In certain instances, all or part of the training data may originate in one or more user equipments (UEs), one or more network entities, or one or more other devices in a wireless communication system. In some cases, all or part of the training data may be aggregated from multiple sources (e.g., one or more UEs, one or more network entities, the Internet, etc.). For example, wireless network architectures, such as self-organizing networks (SONs) or mobile drive test (MDT) networks, may be adapted to support collection of data for ML model applications. In another example, training data may be generated or collected online, offline, or both online and offline by a UE, network entity, or other device(s), and all or part of such training data may be transferred or shared (in real or near-real time), such as through store and forward functions or the like. Offline training may refer to creating and using a static training dataset, e.g., in a batched manner, whereas online training may refer to a real-time or near-real-time collection and use of training data. For example, an ML model at a network device (e.g., a UE) may be trained and/or fine-tuned using online or offline training. For offline training, data collection and training can occur in an offline manner at the network side (e.g., at a base station or other network entity) or at the UE side. For online training, the training of a UE-side ML model may be performed locally at the UE or by a server device (e.g., a server hosted by a UE vendor) in a real-time or near-real-time manner based on data provided to the server device from the UE.

In certain instances, all or part of the training data may be shared within a wireless communication system, or even shared (or obtained from) outside of the wireless communication system.

Once an ML model has been trained with training data, its performance may be evaluated. In some scenarios, evaluation/verification tests may use a validation dataset, which may include data not in the training data, to compare the model's performance to baseline or other benchmark information. If model performance is deemed unsatisfactory, it may be beneficial to fine-tune the model, e.g., by changing its architecture, re-training it on the data, or using different optimization techniques, etc. Once a model's performance is deemed satisfactory, the model may be deployed accordingly. In certain instances, a model may be updated in some manner, e.g., all or part of the model may be changed or replaced, or undergo further training, just to name a few examples.

As part of a training process for an ANN, such as ANN 700 of FIG. 7, parameters affecting the functioning of the artificial neurons and layers may be adjusted. For example, backpropagation techniques may be used to train the ANN by iteratively adjusting weights and/or biases of certain artificial neurons associated with errors between a predicted output of the model and a desired output that may be known or otherwise deemed acceptable. Backpropagation may include a forward pass, a loss function, a backward pass, and a parameter update that may be performed in training iteration. The process may be repeated for a certain number of iterations for each set of training data until the weights of the artificial neurons/layers are adequately tuned.

Backpropagation techniques associated with a loss function may measure how well a model is able to predict a desired output for a given input. An optimization algorithm may be used during a training process to adjust weights and/or biases to reduce or minimize the loss function which should improve the performance of the model. There are a variety of optimization algorithms that may be used along with backpropagation techniques or other training techniques. Some initial examples include a gradient descent based optimization algorithm and a stochastic gradient descent based optimization algorithm. A stochastic gradient descent (or ascent) technique may be used to adjust weights/biases in order to minimize or otherwise reduce a loss function. A mini-batch gradient descent technique, which is a variant of gradient descent, may involve updating weights/biases using a small batch of training data rather than the entire dataset. A momentum technique may accelerate an optimization process by adding a momentum term to update or otherwise affect certain weights/biases.

An adaptive learning rate technique may adjust a learning rate of an optimization algorithm associated with one or more characteristics of the training data. A batch normalization technique may be used to normalize inputs to a model in order to stabilize a training process and potentially improve the performance of the model.

A “dropout” technique may be used to randomly drop out some of the artificial neurons from a model during a training process, e.g., in order to reduce overfitting and potentially improve the generalization of the model.

An “early stopping” technique may be used to stop an on-going training process early, such as when a performance of the model using a validation dataset starts to degrade.

Another example technique includes data augmentation to generate additional training data by applying transformations to all or part of the training information.

A transfer learning technique may be used which involves using a pre-trained model as a starting point for training a new model, which may be useful when training data is limited or when there are multiple tasks that are related to each other.

A multi-task learning technique may be used which involves training a model to perform multiple tasks simultaneously to potentially improve the performance of the model on one or more of the tasks. Hyperparameters or the like may be input and applied during a training process in certain instances.

Another example technique that may be useful with regard to an ML model is some form of a “pruning” technique. A pruning technique, which may be performed during a training process or after a model has been trained, involves the removal of unnecessary (e.g., because they have no impact on the output) or less necessary (e.g., because they have negligible impact on the output), or possibly redundant features from a model. In certain instances, a pruning technique may reduce the complexity of a model or improve efficiency of a model without undermining the intended performance of the model.

Pruning techniques may be particularly useful in the context of wireless communication, where the available resources (such as power and bandwidth) may be limited. Some example pruning techniques include a weight pruning technique, a neuron pruning technique, a layer pruning technique, a structural pruning technique, and a dynamic pruning technique. Pruning techniques may, for example, reduce the amount of data corresponding to a model that may need to be transmitted or stored.

Weight pruning techniques may involve removing some of the weights from a model. Neuron pruning techniques may involve removing some neurons from a model. Layer pruning techniques may involve removing some layers from a model. Structural pruning techniques may involve removing some connections between neurons in a model. Dynamic pruning techniques may involve adapting a pruning strategy of a model associated with one or more characteristics of the data or the environment. For example, in certain wireless communication devices, a dynamic pruning technique may more aggressively prune a model for use in a low-power or low-bandwidth environment, and less aggressively prune the model for use in a high-power or high-bandwidth environment. In certain aspects, pruning techniques also may be applied to training data, e.g., to remove outliers, etc. In some implementations, pre-processing techniques directed to all or part of a training dataset may improve model performance or promote faster convergence of a model. For example, training data may be pre-processed to change or remove unnecessary data, extraneous data, incorrect data, or otherwise identifiable data. Such pre-processed training data may, for example, lead to a reduction in potential overfitting, or otherwise improve the performance of the trained model.

One or more of the example training techniques presented above may be employed as part of a training process. As above, some example training processes that may be used to train an ML model include supervised learning, unsupervised learning, semi-supervised learning, and reinforcement learning technique.

Decentralized, distributed, or shared learning, such as federated learning, may enable training on data distributed across multiple devices or organizations, without the need to centralize data or the training. Federated learning may be particularly useful in scenarios where data is sensitive or subject to privacy constraints, or where it is impractical, inefficient, or expensive to centralize data. In the context of wireless communication, for example, federated learning may be used to improve performance by allowing an ML model to be trained on data collected from a wide range of devices and environments. For example, an ML model may be trained on data collected from a large number of wireless devices in a network, such as distributed wireless communication nodes, smartphones, or internet-of-things (IoT) devices, to improve the network's performance and efficiency. With federated learning, a user equipment (UE) or other device may receive a copy of all or part of a model and perform local training on such copy of all or part of the model using locally available training data. Such a device may provide update information (e.g., trainable parameter gradients) regarding the locally trained model to one or more other devices (such as a network entity or a server) where the updates from other-like devices (such as other UEs) may be aggregated and used to provide an update to a shared model or the like. A federated learning process may be repeated iteratively until all or part of a model obtains a satisfactory level of performance. Federated learning may enable devices to protect the privacy and security of local data, while supporting collaboration regarding training and updating of all or part of a shared model.

In some implementations, one or more devices or services may support processes relating to a ML model's usage, maintenance, activation, reporting, or the like. In certain instances, all or part of a dataset or model may be shared across multiple devices, e.g., to provide or otherwise augment or improve processing. In some examples, signaling mechanisms may be utilized at various nodes of wireless network to signal the capabilities for performing specific functions related to ML model, support for specific ML models, capabilities for gathering, creating, transmitting training data, or other ML related capabilities. ML models performing self-attention, for example, may be employed to support decisions relating to resource allocation or selection, image analysis and reconstruction, classification, error identification and mitigation, etc.

### Example Method for Polynomial Based Transformer Mechanisms

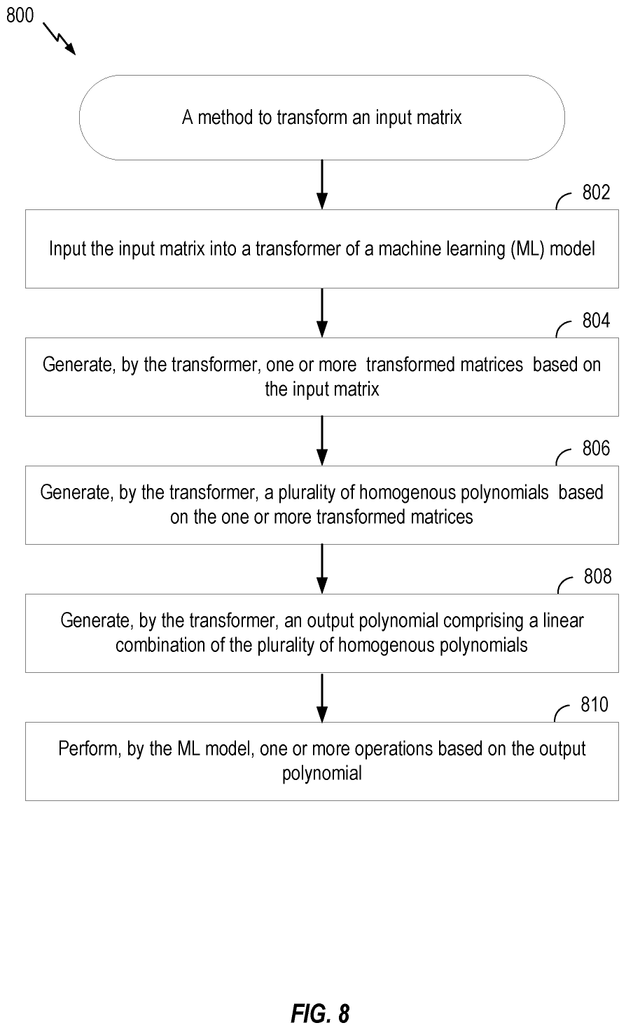

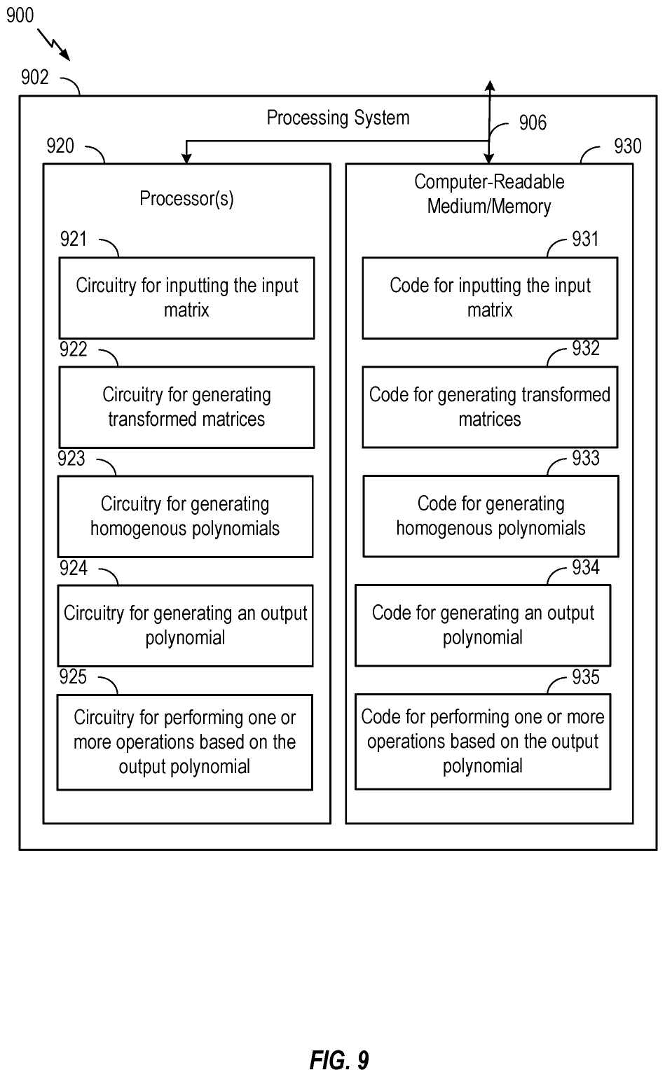

FIG. 8 shows a method 800 directed to polynomial based transformer mechanisms for transforming an input tensor. In one aspect, method 800, or any aspect related to it, may be performed by an apparatus, such as processing system 900 of FIG. 9, which includes various components operable, configured, or adapted to perform the method 800.

Method 800 begins at 802 with inputting the input tensor into a transformer of a machine learning (ML) model.

The method 800 may then proceed to 804 with generating, by the transformer, one or more transformed matrices based on the input tensor.

The method 800 may then proceed to 806 with generating, by the transformer, a plurality of homogenous polynomials based on the one or more transformed matrices.

The method 800 may then proceed to 808 with generating, by the transformer, an output polynomial comprising a linear combination of the plurality of homogenous polynomials.

The method may then end at 810 with performing, by the ML model, one or more operations based on the output polynomial.

In some embodiments, generating the one or more transformed matrices comprises applying, for generation of each of the one or more transformed matrices, a respective first matrix to the left of the input tensor and a respective second matrix to the right of the input tensor.

In some embodiments of method 800, the one or more processors are configured to learn each respective first matrix and each respective second matrix during a training of the ML model.

In some embodiments of method 800, the plurality of homogenous polynomials comprise monomials of the one or more transformed matrices.

In some embodiments of method 800, generating the plurality of homogenous polynomials comprises taking one or more Hadamard products based on the one or more transformed matrices.

In some embodiments of method 800, generating the plurality of homogenous polynomials based on the one or more transformed matrices comprises generating the plurality of homogenous polynomials based on normalized matrices of the one or more transformed matrices.

In some embodiments, the method 800 further comprises learning parameters for performing linear combinations during training of the ML model; and generating the output polynomial is based on the learned parameters.

In some embodiments, the method 800 further comprises generating one or more linear transformations of the output polynomial; and performing the one or more operations based on the output polynomial comprises to perform the one or more operations based on the one or more linear transformations.

In some embodiments of method 800, the output polynomial is representative of an attention mechanism applied to the input tensor.

In some embodiments of method 800, the attention mechanism comprises one of cross attention or self attention.

In some embodiments of method 800, the one or more operations comprise training operations for the ML model.

In some embodiments of method 800, the one or more operations comprise inference operations for the ML model.

In some embodiments of method 800, the one or more operations comprise diffusion operations; and the input tensor comprises a latent image representation of an image.

In some embodiments of method 800, the input tensor comprises a set of token embeddings representing a textual document, and wherein the ML model comprises a language model.

In some embodiments of method 800, the input tensor comprises a set of image features from an input image, and wherein the ML model comprises a vision model.

In some embodiments, the method 800 further comprises acquiring the input image using at least one image sensor.

In some embodiments, the method 800 further comprises receiving the input image using a modem coupled to one or more antennas and one or more processors.

In some embodiments of method 800, the one or more antennas are integrated into one of a vehicle, an extra-reality device, or a mobile device.

In some embodiments of method 800, the ML model comprises a speech recognition model, and wherein the input tensor comprises encoded speech representations derived from an input speech signal.

In some embodiments of method 800, the ML model comprises a recommendation system model, wherein the input tensor comprises at least one of product embeddings or content embeddings.

In some embodiments, method 800 further comprises normalizing each of the one or more transformed matrices prior to generating the plurality of homogeneous polynomials.

Note that FIG. 8 is just one example of a method, and other methods including fewer, additional, or alternative steps are possible consistent with this disclosure.

### Example Processing System for Polynomial Based Transformer Mechanisms

FIG. 9 depicts aspects of an example processing system 900.

The processing system 900 includes a processing system 902 includes one or more processors 920. The one or more processors 920 are coupled to a computer-readable medium/memory 930 via a bus 906. In certain aspects, the computer-readable medium/memory 930 is configured to store instructions (e.g., computer-executable code) that when executed by the one or more processors 920, cause the one or more processors 920 to perform the method 800 described with respect to FIG. 8, or any aspect related to it, including any additional steps or sub-steps described in relation to FIG. 8.

In the depicted example, computer-readable medium/memory 930 stores code (e.g., executable instructions) for inputting the input tensor into a transformer of a machine learning (ML) model 931, code for generating, by the transformer, one or more transformed matrices based on the input tensor 932, code for generating, by the transformer, a plurality of homogenous polynomials based on the one or more transformed matrices 933, code for generating, by the transformer, an output polynomial comprising a linear combination of the plurality of homogenous polynomials 934; and code for performing, by the ML model, one or more operations based on the output polynomial 935. Processing of the code 931-935 may enable and cause the processing system 900 to perform the method 800 described with respect to FIG. 8, or any aspect related to it.

The one or more processors 920 include circuitry configured to implement (e.g., execute) the code stored in the computer-readable medium/memory 930, including circuitry for inputting the input tensor into a transformer of a machine learning (ML) model 921, circuitry for generating, by the transformer, one or more transformed matrices based on the input tensor 922, circuitry for generating, by the transformer, a plurality of homogenous polynomials based on the one or more transformed matrices 923, generating, by the transformer, an output polynomial comprising a linear combination of the plurality of homogenous polynomials 924, and circuitry for performing, by the ML model, one or more operations based on the output polynomial 925. Processing with circuitry 921-925 may enable and cause the processing system 900 to perform the method 800 described with respect to FIG. 8, or any aspect related to it.

### Example Clauses

Implementation examples are described in the following numbered clauses:

Clause 1: A method for transforming an input tensor, comprising: storing the input tensor; inputting the input tensor into a transformer of a machine learning (ML) model; generating, by the transformer, one or more transformed matrices based on the input tensor; generating, by the transformer, a plurality of homogenous polynomials based on the one or more transformed matrices; generating, by the transformer, an output polynomial comprising a linear combination of the plurality of homogenous polynomials; and performing, by the ML model, one or more operations based on the output polynomial.

Clause 2: A method in accordance with Clause 1, wherein generating the one or more transformed matrices comprises applying, for generation of each of the one or more transformed matrices, a respective first matrix to the left of the input tensor and a respective second matrix to the right of the input tensor.

Clause 3: A method in accordance with Clause 2, further comprising learning each respective first matrix and each respective second matrix during a training of the ML model.

Clause 4: A method in accordance with any one of Clauses 1-3, wherein the plurality of homogenous polynomials comprise monomials of the one or more transformed matrices.

Clause 5: A method in accordance with any one of Clauses 1-4, wherein generating the plurality of homogenous polynomials comprises taking one or more Hadamard products based on the one or more transformed matrices.

Clause 6: A method in accordance with any one of Clauses 1-5, wherein generating the plurality of homogenous polynomials based on the one or more transformed matrices comprises generating the plurality of homogenous polynomials based on normalized matrices of the one or more transformed matrices.

Clause 7: A method in accordance with any one of Clauses 1-6, further comprising: learning parameters for performing linear combinations during training of the ML model; and generating the output polynomial is based on the learned parameters.

Clause 8: A method in accordance with any one of Clauses 1-7, further comprising generating one or more linear transformations of the output polynomial; wherein performing the one or more operations based on the output polynomial comprises performing the one or more operations based on the one or more linear transformations.

Clause 9: A method in accordance with any one of Clauses 1-8, wherein the output polynomial is representative of an attention mechanism applied to the input tensor.

Clause 10: A method in accordance with Clause 9, wherein the attention mechanism comprises one of cross attention or self attention.

Clause 11: A method in accordance with any one of Clauses 1-10, wherein the one or more operations comprise training operations for the ML model.

Clause 12: A method in accordance with any one of Clauses 1-11, wherein the one or more operations comprise inference operations for the ML model.

Clause 13: A method in accordance with any one of Clauses 1-12, wherein the one or more operations comprise diffusion operations; and the input tensor comprises a latent image representation of an image.

Clause 14: A method in accordance with any one of Clauses 1-13, wherein the input tensor comprises a set of token embeddings representing a textual document, and wherein the ML model comprises a language model.

Clause 15: A method in accordance with any one of Clauses 1-14, wherein the input tensor comprises a set of image features from an input image, and wherein the ML model comprises a vision model.

Clause 16: A method in accordance with Clause 15, further comprising acquiring the input image with at least one image sensor.

Clause 17: A method in accordance with Clause 15, further comprising receiving via a modem coupled to one or more antennas, and coupled to the one or more processors, the input image.

Clause 18: A method in accordance with Clause 17, wherein the modem and the one or more antennas are integrated into one of a vehicle, an extra-reality device, or a mobile device.

Clause 19: A method in accordance with any one of Clauses 1-18, wherein the ML model comprises a speech recognition model, and wherein the input tensor comprises encoded speech representations derived from an input speech signal.

Clause 20: A method in accordance with any one of Clauses 1-19, wherein the ML model comprises a recommendation system model, wherein the input tensor comprises at least one of product embeddings or content embeddings.

Clause 21: A method in accordance with any one of Clauses 1-20, further comprising normalize each of the one or more transformed matrices prior to generating the plurality of homogeneous polynomials.

Clause 22: A method in accordance with any one of Clauses 1-21, wherein the one or more transformed matrices comprise at least four transformed matrices.

Clause 23: A method for transforming an input, the method comprising: storing the input; obtaining an indication of a number of linear transformations to perform of the input; inputting the input into a transformer of a machine learning (ML) model to perform the number of linear transformations; and performing, by the ML model, one or more operations based on the input and the number of linear transformations.

Clause 24: One or more apparatuses, comprising: one or more memories comprising executable instructions; and one or more processors configured to execute the executable instructions and cause the one or more apparatuses to perform a method in accordance with any one of clauses 1-23.

Clause 25: One or more apparatuses, comprising: one or more memories; and one or more processors, coupled to the one or more memories, configured to cause the one or more apparatuses to perform a method in accordance with any one of Clauses 1-23.

Clause 26: One or more apparatuses, comprising: one or more memories; and one or more processors, coupled to the one or more memories, configured to perform a method in accordance with any one of Clauses 1-23.

Clause 27: One or more apparatuses, comprising means for performing a method in accordance with any one of Clauses 1-23.

Clause 28: One or more non-transitory computer-readable media comprising executable instructions that, when executed by one or more processors of one or more apparatuses, cause the one or more apparatuses to perform a method in accordance with any one of Clauses 1-23.

Clause 29: One or more computer program products embodied on one or more computer-readable storage media comprising code for performing a method in accordance with any one of Clauses 1-23.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured to transform an input tensor, comprising:
one or more memories configured to store the input tensor; and
one or more processors, coupled to the one or more memories, configured to:
input the input tensor into a transformer of a machine learning (ML) model;
generate, by the transformer, one or more transformed matrices based on the input tensor;
generate, by the transformer, a plurality of homogenous polynomials based on the one or more transformed matrices;
generate, by the transformer, an output polynomial comprising a linear combination of the plurality of homogenous polynomials; and
perform, by the ML model, one or more operations based on the output polynomial.

2. The apparatus of claim 1, wherein to generate the one or more transformed matrices comprises to apply, for generation of each of the one or more transformed matrices, a respective first matrix to the left of the input tensor and a respective second matrix to the right of the input tensor.

3. The apparatus of claim 2, wherein the one or more processors are configured to:
learn each respective first matrix and each respective second matrix during a training of the ML model.

4. The apparatus of claim 1, wherein the plurality of homogenous polynomials comprise monomials of the one or more transformed matrices.

5. The apparatus of claim 1, wherein to generate the plurality of homogenous polynomials comprises to take one or more Hadamard products based on the one or more transformed matrices.

6. The apparatus of claim 1, to generate the plurality of homogenous polynomials based on the one or more transformed matrices comprises to generate the plurality of homogenous polynomials based on normalized matrices of the one or more transformed matrices.

7. The apparatus of claim 1, wherein:
the one or more processors are configured to learn parameters for performing linear combinations during training of the ML model; and
to generate the output polynomial is based on the learned parameters.

8. The apparatus of claim 1, wherein:
the one or more processors are configured to generate one or more linear transformations of the output polynomial; and
to perform the one or more operations based on the output polynomial comprises to perform the one or more operations based on the one or more linear transformations.

9. The apparatus of claim 1, wherein the output polynomial is representative of an attention mechanism applied to the input tensor.

10. The apparatus of claim 9, wherein the attention mechanism comprises one of cross attention or self attention.

11. The apparatus of claim 1, wherein the one or more operations comprise training operations for the ML model.

12. The apparatus of claim 1, wherein the one or more operations comprise inference operations for the ML model.

13. The apparatus of claim 1, wherein:
the one or more operations comprise diffusion operations; and
the input tensor comprises a latent image representation of an image.

14. The apparatus of claim 1, wherein the input tensor comprises a set of token embeddings representing a textual document, and wherein the ML model comprises a language model.

15. The apparatus of claim 1, wherein the input tensor comprises a set of image features from an input image, and wherein the ML model comprises a vision model.

16. The apparatus of claim 15, further comprising at least one image sensor configured to acquire the input image.

17. The apparatus of claim 15, further comprising a modem, coupled to one or more antennas, and coupled to the one or more processors, wherein the modem and the one or more antennas are configured to receive the input image.

18. The apparatus of claim 17, wherein the modem and the one or more antennas are integrated into one of a vehicle, an extra-reality device, or a mobile device.

19. The apparatus of claim 1, wherein the ML model comprises a speech recognition model, and wherein the input tensor comprises encoded speech representations derived from an input speech signal.

20. The apparatus of claim 1, wherein the ML model comprises a recommendation system model, wherein the input tensor comprises at least one of product embeddings or content embeddings.

21. The apparatus of claim 1, wherein the one or more processors are configured to normalize each of the one or more transformed matrices prior to generating the plurality of homogeneous polynomials.

22. An apparatus configured to transform an input, comprising:
one or more memories configured to store the input; and
one or more processors, coupled to the one or more memories, configured to:
obtain an indication of a number of linear transformations to perform of the input; and
input the input into a transformer of a machine learning (ML) model to perform the number of linear transformations; and
perform, by the ML model, one or more operations based on the input and the number of linear transformations.
